(19) United States
(12) Patent Application Publication
(10) Pub. No.: US 2025/0342430 A1
(43) Pub. Date: Nov. 6, 2025

(54) System For Enforcing Speed and Meal and Rest Break Rules

(71) Applicant: William B. Trescott, Bay City, TX (US)

(72) Inventor: William B. Trescott, Bay City, TX (US)

(21) Appl. No.: 18/652,945

(22) Filed: May 2, 2024

(51) Int. Cl. G06Q 10/0639; G01C 21/36; G06Q 10/083; G06Q 20/10; G06Q 20/32; G06Q 20/34

(52) U.S. Cl. CPC G06Q 10/0639; G01C 21/3691; G06Q 10/083; G06Q 20/10; G06Q 20/3223; G06Q 20/341

(57) ABSTRACT

A system for enforcing speed and meal and rest break rules that converts lump sum mileage payments into hourly wages. A motion sensor transmits the time an operator has been on duty along with any time speed or meal or rest break rules were violated to a financial institution. A mapping program calculates minimum safe pickup and delivery times based on the number of miles to be driven, the speed limits en-route, and the amount of time the operator will need to eat, sleep, and rest. If the operator finishes the trip in less than the minimum safe pickup and delivery times, such as if the time saved resulted from violation of speed limits or meal or rest break rules, an amount of payment proportional to the time not worked can be rebated to the employer or transferred to a state or local government as a civil penalty.

### BACKGROUND OF INVENTION

The present invention relates to vehicles for transporting persons, animals, or goods, and in particular to vehicles operated by drivers paid for their services in wages proportional to the number of miles they drive who are pressured to violate speed limits, skip meals and rest breaks, or drive without adequate sleep to maximize their incomes.

Vehicles, trucks, and busses large enough to knock down buildings and crush other vehicles are often driven long distances on the highway posing a life threatening danger to the public when their operators become fatigued or fall asleep at the wheel. Truckload motor carriers usually provide trucks with drivers to customers in exchange for mileage pay. Less than truckload carriers usually charge in proportion to the cargo weight multiplied by the number of miles in transport. Intermodal carriers usually charge by the size and number of containers to be carried times the number of miles to be driven. Regardless of the method for calculating payment, it is in the interest of drivers paid by the mile to travel as fast and as far as possible each day to maximize their incomes. It is an object of the present invention, therefore, to provide a process for converting lump sum mileage payments into hourly wages to eliminate any incentive for drivers to be overworked.

Further, it is known to provide vehicles with tracking devices to limit the number of hours drivers are permitted to drive. Such devices require drivers to violate speed limits whenever delayed by weather or traffic, or else park on the roadside or highway exit ramps when they run out of driving time. Such devices pose an additional hazard if drivers are assaulted, robbed, or struck by other fatigued drivers while attempting to sleep in an unsafe location, or fall asleep at the wheel attempting to drive without adequate rest after being kept awake by passing traffic. Tracking devices effectively ban innovation as immobile drivers have no means of protecting their trade secrets. It is a further object of the present invention, therefore, to eliminate any pressure for fatigued drivers to eat or sleep in their vehicles.

It is well known to access bank accounts using magnetically activated credit and debit cards containing computer chips as extensively cited in U.S. Pat. No. 11,238,426 to Lamba, originally invented in Japan by Kusakabe in 1997. It is known to transmit biometric data to vehicles using portable communication devices as shown in U.S. Pat. No. 9,082,237 to Breed. It is also known to store vehicle pickup and delivery information in a computerized dispatch system using portable media as shown in U.S. Pat. Nos. 11,562,316 and 11,941,574 to Haque or U.S. Pat. No. 9,928,475 to Burnett. As taught by Burnett and Haque, such dispatch systems can allocate drivers to trips so as to make maximum use of vehicles and minimize the mileage they must to drive to accomplish their tasks. It is a further object of the present invention, therefore, to depart from the teachings of Breed, Burnett, and Haque to maximize safety instead of productivity by eliminating unscrupulous middlemen who are the source of the problem.

Instead of using biometric data to access a vehicle as described by Breed, data such as time on task fatigue can be transmitted from a vehicle to a device and then to a bank account or similar fiduciary instrument such as from an insurance company to prevent drivers from being paid more if they are overworked. It is a further object of the present invention, therefore, to provide a simplified banking interface to allow any member of the public to employ a driver without incurring liability resulting from negligent hiring and without the expense and complexity of a separate computerized dispatch system to monitor drivers as described by Burnett and Haque.

### SUMMARY OF INVENTION

The system for enforcing speed and meal and rest break laws of my invention comprises a bank account or similar fiduciary instrument accessed by a computer, a portable communication device such as a cell phone or debit card capable of initiating financial transactions, and a motion sensor capable of transmitting the amount of time a driver has been on duty along with any time the driver has driven in violation of speed and meal and rest break rules. When the driver purchases fuel, repairs, meals, or pays for any other business expense using the device, the number of hours worked and driven in violation is transmitted to the financial institution along with the location of the transaction.

The financial account is accessed by brokers, carriers, shippers, consignees, or anyone wishing to employ a driver using an online computer interface. When an employer enters pickup and delivery locations into a computer, a mapping program estimates the trip time based on the number of miles to be driven, the speed limits en-route, and the amount of time the driver will need to eat, sleep, and rest without the need for a computerized dispatch system. The trip time is combined with the location and number of hours worked transmitted from the vehicle to calculate the minimum safe pickup and delivery times. To avoid liability resulting from negligent hiring, the employer enters pickup and delivery appointments scheduled to occur after these minimum times along with a method of payment.

Unless the driver refuses employment, the system schedules an automatic financial transaction to occur following the last delivery appointment and divides the amount of the transaction by the number of hours needed to safety complete the trip. The driver may then spend an amount proportional to the hours worked on fuel, repairs, meals, or any other tax deductible business expense needed to satisfy the employer's needs. Should the driver withdraw cash or transfer funds into a personal account, the amount will be reported to the Internal Revenue Service as income. If the driver fails to complete the trip or finishes the trip in less time than expected, an amount of payment proportional to the time not worked can be rebated or deducted from the transaction. Alternatively, if the system calculates that the time saved resulted from violation of speed limits or meal or rest break rules, an amount of payment proportional to the time not worked can be diverted to a third party such as a state or local government as a civil penalty.

### BRIEF DESCRIPTION OF DRAWINGS

FIG. 1 is front plan view of a portable media communication device containing a computer chip and driver's license information according to the present invention.

FIG. 2 is side perspective view of a vehicle equipped with a computerized 12) motion sensor and transmitter according to the present invention.

FIG. 3 is a flow chart illustrating the process performed by the computerized motion sensor shown in FIG. 2.

FIG. 4 is a flow chart illustrating the process performed by a financial institution when a vehicle operator initiates a transaction according to the present invention.

FIG. 5 is a flow chart illustrating the process performed by a financial institution when a prospective employer enters an account or driver's license number into a computer interface according to the present invention.

FIG. 6 is a flow chart illustrating the process performed by a financial institution when a prospective employer schedules a pickup appointment on a computer interface according to the present invention.

### DETAILED DESCRIPTION

I will now describe my preferred embodiment of my invention with reference to the accompanying drawings, wherein like numerals are used to refer to like parts.

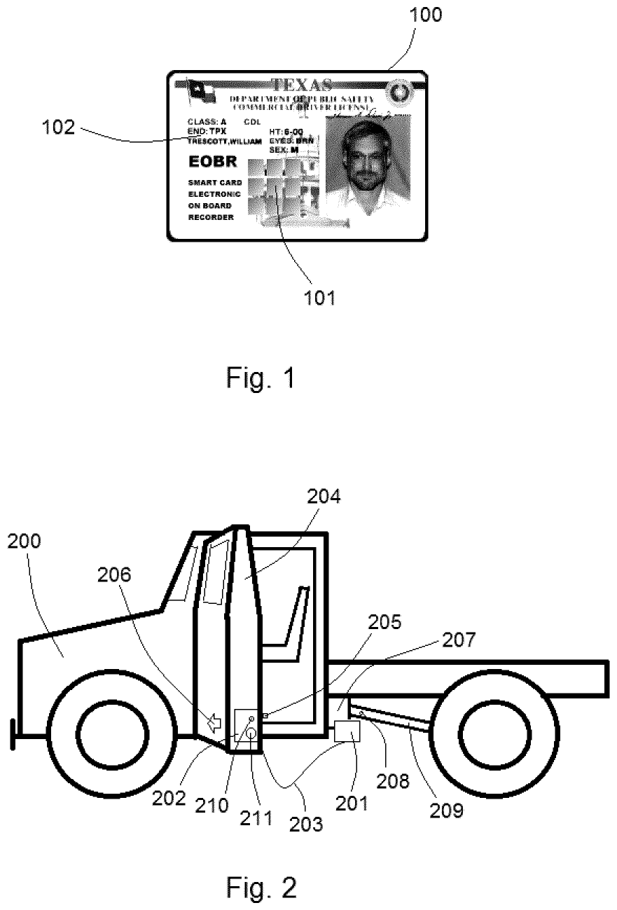

FIG. 1 shows a frontal view of a portable media communication device 100 containing a computer chip 101 according to my invention. Similar to an ordinary smart credit or debit card for durability, it is preferred that it be personalized with 102 drivers license information issued by a state in the same manner as a driver's license card, though it will be understood that it could be personalized in some other way or left blank for security reasons. A self-driving vehicle may have an operator who is not a professional driver, for instance. Because some states are considering issuing electronic driver's licenses and other users may have no need for a separate card, cell phones, tablets, human embedded biometric microchips, or similar portable electronic devices (not shown) may also be used. Alternatively, if the vehicle itself is connected to the internet through an online system allowing a vehicle to communicate with a financial institution directly, the portable media communication device may be omitted without departing from the teachings of my invention.

FIG. 2 is a left side view of a vehicle 200 equipped with a computerized motion sensor 201 according to my invention attached to a magnetic induction transmitter 202 by a wire 203 capable of transmitting data to the portable media communication device 100 of FIG. 1. Although the wire is shown dangling as it would during installation, it will be understood that it can easily be secured underneath the vehicle for durability. Although the transmitter 202 is shown located on the bottom inside end of the open driver's door 204 as on a large truck, it could be located higher up on a smaller vehicle so that it can better communicate with a device carried by a driver without having to remove it from a pocket, for example. Because the range of such devices is limited by the wavelength used, a 10 cm or longer radio wave with a frequency of 2-3 GHz is preferred. Because longer wavelengths cause interference with other electronic devices nearby, it will be understood that opening the door containing the transmitter and pulling it toward the device will reduce the energy required and improve reliability without inconveniencing the operator. Alternatively, a two transmitter system could be used, though at higher cost, with the second transmitter located in the door sill (not shown) so as to automatically transmit to devices passing between the two transmitters when the door is open to save the operator the inconvenience of pulling the door toward the device. A spring loaded extending button 205 can activate the transmitter when the door 204 is opened or the door handle 206 is pulled allowing the button 205 to extend so continuous operation will not run down the vehicle batteries. Although the motion sensor 201 is shown attached to the transmission 207 to detect a rotating magnet 208 attached to the drive shaft 209 in the same manner as a bicycle cyclometer, an inexpensive sensor equipped with a removable card slot or wireless connectivity could also be used in the same manner as a wireless bicycle cyclometer. Alternatively, the sensor could be attached to a vehicle electronic control unit (not shown) if the vehicle is equipped with electronic engine controls or integrated with such controls at the time of manufacture without departing from the teaching of my invention. A flashing light 210 indicates when the transmitter is active which could alternatively be located near the dashboard to warn if a driver is in violation of meal or rest break laws. A small speaker 211 will emit a sound when data transfer is complete.

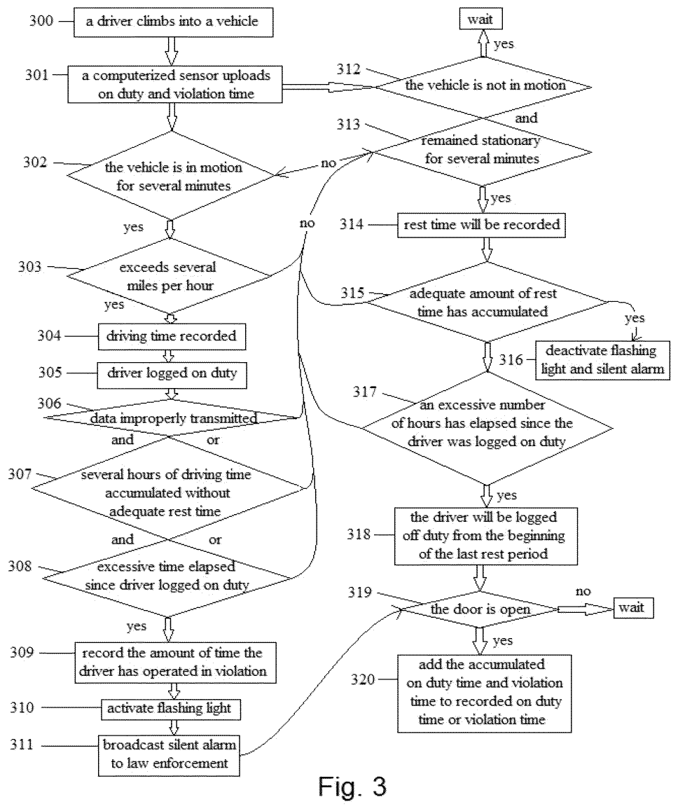

FIG. 3 is a flow chart 300 illustrating the process performed by the motion sensor 201 of FIG. 2 to record compliance with the following preferred set of rules:

Commercial motor vehicle operators MUST cease all work for 10 uninterrupted hours after each 14 hours on duty.

Commercial motor vehicle operators MUST rest a total of one hour during each 7 hours on duty.

Commercial motor vehicle operators may not be dispatched to drive more than 10 hours in a 24 hour period or be on duty more than 70 hours in any time period unless an equivalent number of hours are logged off duty.

No more than six consecutive hours of driving or other labor may be performed without an on duty rest period and no more than 12 hours of driving and/or other labor may be performed within any 24 hour period.

Drivers may inspect and count freight, monitor gauges, inspect their vehicles for safety defects, complete paperwork, wait for dispatch, wait for loading or unloading, or wait for repairs during on duty rest periods.

Drivers MAY NOT drive, operate material handling equipment, touch or wrap freight, connect hoses, or perform any labor that would prevent eating or sleeping during on duty rest periods. Any task requiring the use of both hands MAY NOT be performed during on duty rest periods.

Smart card Electronic On Board Recorders (EOBR's) will be issued by each of the 50 States with a new Commercial Driver's License (CDL) permanently laminated to the front with a tamper evident seal.

Commercial vehicles will be equipped with an inexpensive magnetic SENSOR capable of recording and transmitting vehicle speed to nearby EOBR's in the same manner as a wireless bicycle cyclometer.

ALL movements of the vehicle exceeding 5 minutes and 5 mph will automatically be recorded as ON DUTY.

Whenever a vehicle is stationary longer than five minutes, EOBR's will automatically record REST periods and log drivers OFF DUTY from the time of the last vehicle movement 14 hours after the first vehicle movement.

Vehicles must remain stationary during REST periods unless a second EOBR is logged ON DUTY

Although the above rules extrapolated from Section 11090 of the California Labor Code are preferred because they have proven effective at saving lives by the National Highway Traffic Safety Administration's Fatality Analysis Reporting System and were enacted in part as the Commercial Motor Vehicle Safety Enhancement Act of 2012, first published online in December 2008, it will be understood that only a system for enforcing speed and meal and rest break rules is claimed, not a preferred set of rules. A state may change its laws at any time and many states have meal and rest break rules different than those of California that may in time be proven superior. It is a further object of the present invention, therefore, that the flow chart 300 of FIG. 3 can be adapted to simultaneously enforce several different rules in different jurisdictions as a vehicle moves from place to place or incorporated into a computerized dispatch system having rules different than those described above without departing from the teachings of my invention.

As shown in FIG. 3, whenever 300 a driver climbs into a vehicle, 301 a computerized sensor 201 of FIG. 2 uploads any on duty or violation time recorded on a media communication device 100 of FIG. 1 carried by the driver with a check digit revealing whether the driver was logged on duty if the driver has been operating other similarly equipped vehicles. If 302 the vehicle is in motion for several minutes and 303 exceeds several miles per hour, 304 driving time will be recorded and if 305 the driver is not already on duty as recorded on the device, the check digit will be changed to indicate on duty. If 306 no device is present, or data contained on the device is improperly transmitted, or 307 several hours of driving time has accumulated without adequate rest time needed for safety, or 308 an excessive number of hours has elapsed since the driver was logged on duty, 309 the sensor will record the amount of time the driver has operated in violation, 310 activate a flashing light 210 of FIG. 2, and optionally 311 broadcast a silent alarm to law enforcement. The alarm can be transmitted in a variety of computer readable formats as might be required by a state at a commercial motor vehicle inspection facility. As different states have different rules, it will be understood that the system may need to determine the most restrictive rule in every jurisdiction on a vehicle's route to determine what is adequate or excessive. The operator of a self-driving vehicle may have different rules than a skilled professional driver apprenticed in the trade, for example. If 312 the vehicle is not in motion, and 313 has remained stationary for several minutes, 314 rest time will be recorded. If 315 an adequate amount of rest time has accumulated, the sensor will 316 deactivate the flashing light 210 of FIG. 2 and silent alarm. If 317 the vehicle is not in motion and an excessive number of hours has elapsed since the driver was logged on duty, 318 the driver will be logged off duty from the beginning of the last rest period. If 319 the door is open, 320 the transmitter 202 of FIG. 2 will add the accumulated on duty time and violation time to any on duty time or violation time recorded on the portable device in previous transmissions.

If the portable media communication device is a debit card or similar smart card, the data may need to be compressed into a two key authentication system with check digits for secure communication with a financial institution. In this case, the sensor may record time in five minute intervals rounded up into tenths of an hour. Thus, after five minutes have elapsed, six minutes may be recorded. Because computers communicate in binary numbers, six minutes of rest time may be represented by 1, an hour of driving time by 1010, three hours of violation time by 11110, and twenty four hours of on duty time by 11110000, for instance. Thus, one skilled in the art will understand that several thousand hours of accumulated on duty and violation time could be transmitted using just 32 bits of data, leaving room for a check digit to record a 1 if the driver has been logged on duty and a 0 if not along with the location of the merchant as part of the secure data stream that accompanies a debit or credit card transaction. Larger amounts of data such as rest, off duty, and driving time could also be sent without departing from the teachings of my invention.

Because fleet vehicles are often keyed alike, that is, a key that unlocks the door of one vehicle will unlock the doors of every other vehicle manufactured under the same purchase order, it is a goal of my invention to end the practice of dispatchers revealing the locations of female drivers to those having keys that will unlock their vehicles so they can be assaulted when they sleep. Because of Selective Availability, the Global Positioning System often inaccurately records location. Truckers have observed trucks apparently driving in circles on electronic logging devices when backed into loading docks with their engines turned off. Sailors have noticed boats apparently jumping out of the water and slamming into buildings on their chart plotters when sitting quietly at anchor. It is a goal of my invention, therefore, to provide law enforcement with vehicle locations accurate enough to be used as evidence in court without endangering female drivers or revealing the locations of vehicles containing trade secrets. For instance, if a driver pays for a meal at one truck stop, then buys fuel at another in less time than can be traveled without violating the speed limit, the transaction times would indisputably prove that the driver was guilty of speeding. If the vehicle 200 of FIG. 2 ran over a car and caught fire, destroying the motion sensor 201, or transmitter 202, the computer chip 101 on the portable media device 100 of FIG. 1 would indisputably prove that the driver was guilty of manslaughter if the elapsed time since the last transaction revealed that speed limits were violated or mandatory rest breaks were skipped. It will be understood that the sensor 201 could be provided with an internal battery to record a rest break on the device even if electrical power was interrupted as a result of a crash or vehicle repair. Because electronic devices are often destroyed in crashes and internet connectivity is often poor in mountainous regions, a smart card that can be rescued by emergency personnel in the pocket of its driver is preferred over a device that is likely to be left behind in a cell phone holder or card slot. Also, a smart driver's license card that remains the property of an issuing state is preferred over a crash survivable black box or personal device that can be searched only with a search warrant. It is a further object of the present invention, therefore, to provide law enforcement with the ability to contact employers before they learn that a crash has occurred to ascertain if a driver was pressured to pickup or deliver as soon as possible rather than obeying speed limits or stopping for breaks. One skilled in the art will understand that if the vehicle itself has internet connectivity and can automatically call for help, on duty and violation time could immediately be transmitted to law enforcement without departing from the teaching of my invention.

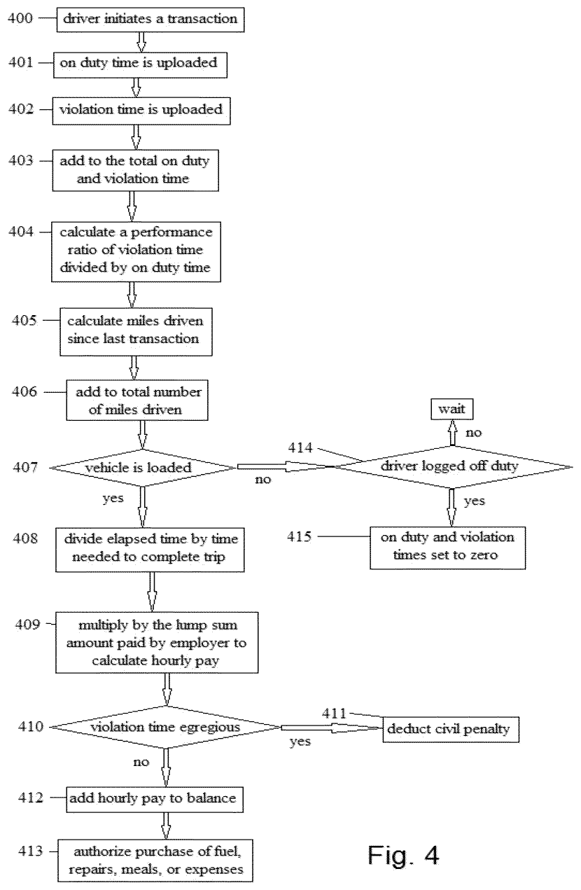

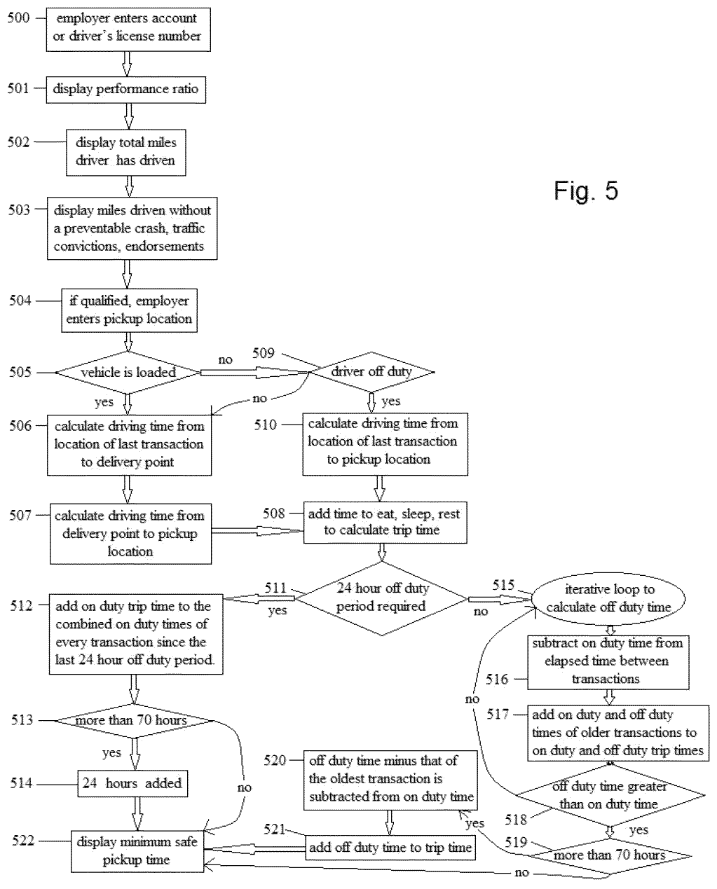

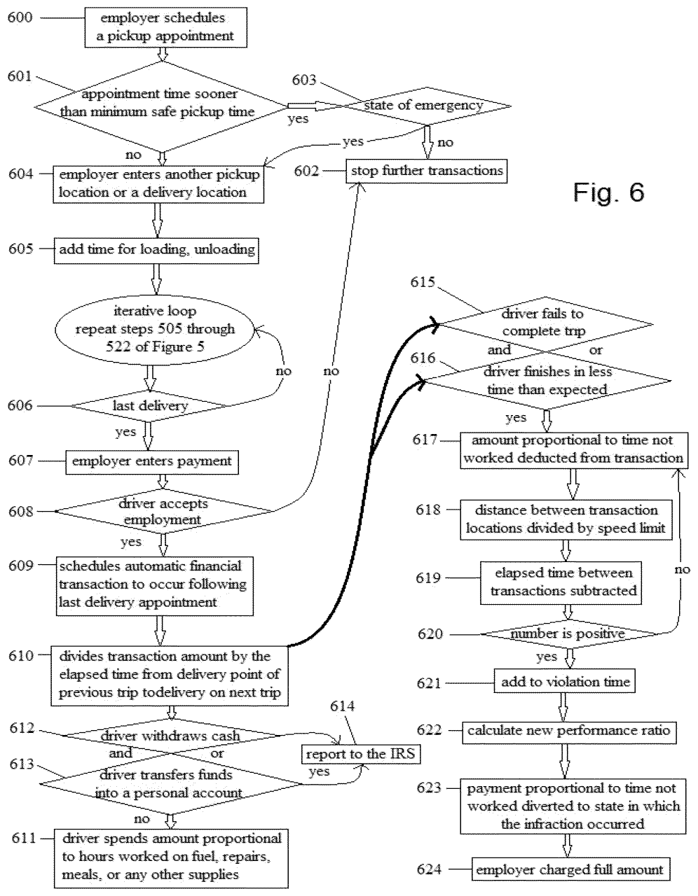

FIG. 4 is a flow chart 400 illustrating the process performed by a financial institution when a driver initiates a transaction. First, 401 on duty time and 402 violation time is uploaded from the portable media communication device 100 of FIG. 1 and stored. Then 403 the computer will add these to the total on duty and violation time to 404 calculate a performance ratio of total violation time divided by total on duty time. Using a mapping program, the computer will 405 calculate the number of miles driven since the last transaction and 406 add this to the total number of miles the driver has driven using the system. If 407 the vehicle is loaded, the computer will 408 divide the elapsed time since the last transaction by the estimated number of hours needed to complete the trip from start to finish 610 of FIG. 6 and multiply that by the lump sum amount paid by the employer 607 to 409 calculate how much hourly pay the driver is owed. Alternatively, 410 if the amount of violation time is egregious, 411 a civil penalty can be deducted. Finally, 412 the hourly pay is added to the debit card or account balance available to 413 authorize the transaction allowing the driver to purchase fuel, repairs, meals, or pay for other business expenses. If 414 the driver has been logged off duty, 415 on duty and violation times stored on the device are reset to zero so the driver can change vehicles without setting off an alarm. Should some other form of payment such as cash or check be used to avoid the penalty, the driver will be working for free and unable to change vehicles.

It will be understood that the operator must have some incentive to voluntarily use the system such as immediate payment to avoid card read errors resulting from incomplete data transfer should the driver quickly jump out of the vehicle without waiting for the system to update. If the financial institution is an insurance company, a driver might qualify for a lower insurance rate using the system, or be charged a higher rate for abusing it. It is a further goal of the present invention, therefore, to enable insurance companies to underwrite employers on a per-trip basis to ensure that assigned tasks fall within an operator's skills and abilities. An unskilled trainee may wish to avoid the mountains in winter or a self-driving vehicle might be banned in icy conditions, for example, while an experienced professional might qualify for a lower insurance rate in hazardous conditions.

FIG. 5 is a flow chart 500 illustrating the process performed by a financial institution when a prospective employer enters the debit card, fiduciary account, or driver's license number of an operator into a computer interface. First, the computer 501 displays the driver's performance ratio 404 of FIGS. 4 and 502 the total number of miles the driver has driven 406 of FIG. 4 with an optional insurance quote to protect the employer from negligently hiring an unqualified trainee. Unskilled motorists attempting to drive trucks are as much a threat to the safety of truckers as ordinary motorists are to each other, thus it is a goal of my invention to protect the rights of highway workers to safety in their workplaces. A robotic vehicle can only drive as well as the person who programs it, so an unskilled operator may need to be even more vigilant than a professional driver and therefore require more frequent or longer breaks. Stepping on a computer mouse resembling a brake pedal to record preference for deceleration in a vehicle electronic control unit is simply not the same as steering around an obstacle to avoid a crash. Alternatively, a state may wish to 503 display information on miles driven without a preventable crash, traffic convictions, and/or double trailer, hazardous material, tanker, or passenger endorsements that a prospective employer may wish to consider in making a hiring decision.

If the operator is considered qualified, 504 the employer enters a pickup location. If 505 the vehicle is loaded, a mapping program 506 calculates the driving time from the location of the last transaction to the delivery point by dividing the number of miles by the speed limits en-route and then 507 calculates the driving time from the delivery point to the pickup location, then 508 adds the amount of time the driver will need to eat, sleep, and rest according to the most restrictive rules of the jurisdictions through which the vehicle must pass. For example, if a driver must drive four hundred miles to a delivery point and two hundred miles to a pickup location and the speed limit is 65, then ten hours of driving will be required at an average speed of 60 mph. Under the preferred rules described above, one hour of breaks will be needed during the first seven hours and two hours will be needed to unload, so the on duty time would be thirteen hours. If the driving time is eleven hours or the on duty time is fourteen hours, ten hours of off duty time must be added according to the preferred rules and the total trip time would be twenty four hours. An artificial intelligence program could be used to estimate the travel and unloading times based on other drivers' experience with the traffic conditions and type of customer. It will be understood that a moving van may need six hours or more to unload depending on the weight of household goods to be delivered, while a flatbed might be unloaded in only fifteen minutes. A loaded vehicle may take longer to climb over a mountain pass than an empty one, for example. If the vehicle is empty and 509 the driver was logged off duty in the last transaction, 510 the trip time will be calculated based on the number of miles to be driven from the location of the last transaction to the pickup location in the same manner described above with 508 additional time for breaks added as required by the rules. Because most states limit the number of hours per week a driver can be on duty to 70 unless 511 a 24 hour off duty period is logged, 512 on duty trip time is added to the combined on duty times 401 of FIG. 4 uploaded from the device in every transaction since the last 24 hour off duty period. If 513 more than seventy hours has been recorded, then 514 twenty four hours is added to the total trip time. However, being unable to flee from stalkers for 24 hours exposes female and younger male drivers to additional danger from assault. Therefore, the preferred rules ensure that vehicles can be moved when necessary for safety, so drivers may not be dispatched to be on duty more than 70 hours unless an equivalent number of hours are logged off duty. The preferred rules do not require that the vehicle remain stationary for 24 hours. Instead, the computer must perform an 515 iterative loop, to calculate off duty time by 516 subtracting on duty time from the elapsed time between transactions and 517 repeatedly adding the on duty and off duty times of increasingly older transactions to the on duty and off duty trip times until 518 the off duty time is greater or equal to the on duty time. If 519 the accumulated number of on duty hours is greater than 70, then 520 the number of off duty hours accumulated minus the off duty hours of the oldest transaction is subtracted from the on duty hours accumulated to calculate the number of 521 off duty hours that must be added to the total trip time under the preferred rules to calculate 522 the minimum safe pickup time. It will be understood that when drivers return home, several days may elapse without any transactions, thus only the on duty time of the oldest transaction will be added to the on duty time of the following trip. It is a goal of my invention to encourage employers to schedule off duty time at drivers' homes to achieve maximum productivity, therefore, under the preferred rules, off duty time away from home will result in longer trip times and lower pay for the driver.

FIG. 6 is a flow chart illustrating the process performed by a financial institution when 600 a prospective employer schedules a pickup appointment. If 601 the employer chooses an appointment time sooner than the minimum safe pickup time, 602 the interface will stop further transactions unless 603 the government has declared a state of emergency such as if a snow plow or wreaker driver must clear a road immediately. If the appointment time is acceptable according to the rules of the governing jurisdiction, the employer 604 enters either another pickup location or a delivery location. After each pickup or delivery location is entered, 605 the computer adds additional on duty time for loading and unloading and repeats steps 505 through 522 of FIG. 5. If 606 the last delivery appointment is scheduled, 607 the employer enters an amount and method of payment such as credit card or account numbers.

If 608 the driver accepts employment through voice or text etc., 609 the system schedules an automatic financial transaction to occur following the last delivery appointment and 610 divides the amount of the transaction by the number of hours that will elapse traveling from the delivery point of drivers current or previous trip to the place of the last delivery appointment on the scheduled trip 408 of FIG. 4. The driver then 611 spends an amount proportional to the hours worked on fuel, repairs, meals, or any other supplies needed to satisfy the employer's needs. Although the financial institution may occasionally need to provide overdraft protection until the payment actually arrives, most drivers will prefer to keep a balance to cover the cost of expensive repairs or emergency travel home, so in most cases it will make money by reinvesting the balance in the same manner as an ordinary bank account. A service charge may be deducted if the average balance falls below a required amount needed for profitability. If 612 the driver withdraws cash or 613 transfers funds into a personal account, 614 the amount will be reported to the Internal Revenue Service as income with optional withholding. If 615 the driver fails to complete the trip or 616 finishes the trip in less time than expected, such as if the vehicle breaks down or if the vehicle is loaded or unloaded more quickly than expected, 617 an amount of payment proportional to the time not worked will be deducted from the scheduled transaction. Alternatively, to ensure that the time saved has not resulted from violation of speed limits or rest break laws, 618 the map distance between transaction locations is divided by the speed limits en-route and 619 the elapsed time between transactions is subtracted. If 620 the number is positive, it will be 621 added to the accumulated violation time 402 of FIG. 4 uploaded from the portable media device 100 of FIGS. 1 to 622 calculate a new performance ratio of total violation time divided by total on duty time 404 of FIG. 4. An amount of 623 payment proportional to the time not worked can be diverted to the jurisdiction in which the infraction occurred and 624 the employer will be charged the full amount of the scheduled transaction. It is a further goal of my invention, therefore, to reward employers that load and unload vehicles quickly with rebates and punish those who detain drivers or otherwise pressure them to violate speed, meal, or rest break laws by requiring them to pay the full amount. An artificial intelligence program may be used to prevent errors such as if a merchant records a billing address of a transaction instead of a physical address or if a driver is on duty and not resting such as when buying fuel instead of eating a meal. It is a further goal of my invention, therefore, to accurately and automatically record on duty, meal, and rest times as required under the Commercial Motor Vehicle Safety Enhancement Act when multiple transactions occur at one location such as when a driver buys fuel and then a meal.

One skilled in the art will recognize that other methods for providing controls may be selected without departing from the teachings of this invention.

Although I have now described my invention in connection with my preferred embodiment, those skilled in the art will recognize that my invention may take other forms without departing from the spirit or teachings thereof. The forgoing description is intended, therefore, to be illustrative and not restrictive, and the scope of my invention is to be defined by the following claims:

1. A system for enforcing speed and meal and rest break rules, the system comprising
a first computer and at least one second computer having means to control a first and second financial account or fiduciary instrument,
a sensor producing a signal representative of the motion of a vehicle, said sensor connected to said first computer having means to record vehicle speed, duration of motion, and elapsed time between motions of said vehicle,
said first computer having means to record identity, on duty status, on duty time, and driving time of at least one operator, altering said status, on duty time, and driving time responsive to said speed, elapsed time, and duration of motion,
at least one set of rules enacted by a state, government, union, or corporation determining amounts of meal, rest, and off duty time required for safety during said on duty and driving time,
said first computer subtracting elapsed time between motions of said vehicle from said amounts of meal, rest, and off duty time required for safety and adding the remainders to calculate violation time, having means to communicate said on duty and violation time of said operator to said second computer,
said second computer having means to initiate, change, or stop financial transactions between said first and second financial accounts responsive to alterations in on duty and violation time communicated from first computer,
an online computer server interface operable to record at least one pickup location and at least one delivery location of a vehicle and transfer funds from an external financial account or fiduciary instrument into said first financial account or fiduciary instrument,
a computer mapping program having means to calculate distance between at least one pickup location and at least one delivery location and dividing said distance by at least one speed limit to determine minimum safe driving time for an operator, said second computer adding said amount of meal, rest, and off duty time required for safety to said minimum safe driving time to calculate minimum safe trip time,
said second computer having means to hold said funds of said first account in escrow and transfer said funds to said second account in proportion to the fractional amount of said minimum safe trip time completed and rebating funds in proportion to the fractional amount of said minimum safe trip time not completed.

2. The system of claim 1 wherein said first account is a pending transaction account sharing the same account number of said second account,
said second computer having means to advance funds to said second account in proportion to the fractional amount of said minimum safe trip time completed and reduce the amount of a pending transaction in proportion to the fractional amount of said minimum safe trip time not completed.

3. The system of claim 1 wherein said second computer subtracts said amount of off duty time required for safety according to said rules from said on duty time to calculate additional violation time.

4. The system of claim 3 wherein said computer mapping program calculates distance between transactions and divides said distance by at least one speed limit to determine minimum safe driving time and subtracts elapsed time between transactions to calculate additional violation time.

5. The system of claim 4 wherein said second computer divides total violation time by total on duty time of said operator to calculate a performance ratio and displays said performance ratio on said online computer server interface.

6. The system of claim 4 wherein said second computer transfers said funds of said first account to a third financial account or fiduciary instrument controlled by a state, government, union, corporation, or other entity in proportion to said violation time, additional violation time, or total violation time.

7. The system of claim 1 wherein said minimum safe driving time is calculated by an artificial intelligence program averaging the travel times of a large number of similar vehicles in similar weather and traffic conditions.

8. The system of claim 1 wherein said minimum safe trip time is calculated by an artificial intelligence program averaging the loading and unloading times of a large number of similar vehicles at similar pickup and delivery locations or at a particular pickup and delivery location.

9. The system of claim 1 wherein said second computer adds said minimum safe trip time to current time to calculate minimum safe pickup time and displays said minimum safe pickup time on said online computer server interface.

10. The system of claim 1 wherein said second computer adds said minimum safe trip time to the delivery time of a loaded vehicle to calculate minimum safe pickup time and displays said minimum safe pickup time on said online computer server interface.

11. The system of claim 1 wherein said online computer server interface is operable to record at least one pickup time and at least one delivery time and adding said minimum safe trip times for each pickup and delivery time to calculate additional minimum safe pickup and delivery times and display said minimum safe pickup and delivery times on said online computer server interface.

12. The system of claim 11 wherein said online computer server interface prevents transfer of funds from an external financial account or fiduciary instrument into said first financial account or fiduciary instrument when a pickup or delivery time is scheduled to occur prior to a corresponding minimum safe pickup or delivery time.

13. The system of claim 11 wherein said online computer server interface requires a government declaration of a state of emergency prior to transferring funds from an external financial account or fiduciary instrument into said first financial account or fiduciary instrument when a pickup or delivery time is scheduled to occur prior to a corresponding minimum safe pickup or delivery time.

14. The system of claim 1 further comprising wireless connectivity.

15. The system of claim 14 further comprising a silent alarm.

16. The system of claim 1 further comprising a portable media communication device capable of initiating financial transactions.

17. The system of claim 16 wherein said portable media communication device is a telephone or computer.

18. The system of claim 16 wherein said portable media communication device is a smart credit or debit card or biometric chip.

19. The system of claim 18 wherein said card or chip is personalized with driver's license information.

20. The system of claim 18 wherein said on duty and violation time is compressed to accompany a security authentication code of said card or chip.

21. The system of claim 1 wherein said sensor is connected to a vehicle drive train.

22. The system of claim 1 wherein said sensor is connected to a vehicle electronic control unit.

23. The system of claim 1 wherein said sensor further comprises a magnetic induction transmitter capable of transmitting and receiving data to and from a portable media communication device.

24. The system of claim 23 wherein said transmitter is connected to a vehicle door such that when the door is opened, it transmits data to and from a portable media communication device.

25. The system of claim 23 wherein said transmitter is connected to the open end of a vehicle door.

26. The system of claim 23 wherein said transmitter is connected to a vehicle door or door sill further comprising a second transmitter connected to a door sill so as to transmit data to and from a portable media communication device passing between the two said transmitters.
